(19) United States
(12) Patent Application Publication
(10) Pub. No.: US 2017/0039662 A1
(43) Pub. Date: Feb. 9, 2017

(54) SYSTEM AND PROCESS FOR MANAGING THE COMPLETE LIFE CYCLE OF A GRIEVANCE COMPLAINT OR ARBITRATION REQUEST

(71) Applicants: Elizabeth McKenna, Chicago, IL (US); Warren McKenna, Chicago, IL (US)

(72) Inventors: Elizabeth McKenna, Chicago, IL (US); Warren McKenna, Chicago, IL (US)

(21) Appl. No.: 14/821,250

(22) Filed: Aug. 7, 2015

(51) Int. Cl. G06Q 50/18; G06Q 10/06; G06F 17/30

(52) U.S. Cl. CPC G06Q 50/182; G06F 17/30525; G06Q 10/0633; G06Q 10/063118

(57) ABSTRACT

A multi-module based system has been created to manage the complete lifecycle of Grievance and/or Arbitration proceedings within an organization whose constituents abide by a code of ethics and/or professional standards, and/or professional practices, and/or code of conduct in a database system for both industry professionals and consumers. The system incorporates 4 separate modules that support the grievance submission, processing and administration, volunteer management and administration and system reporting. Module 1 (Complaint Submission) provides the intake of claims and/or request for mediation or arbitration. Module 2 (Case Administration) manages the workflow and processing of all submitted claims. Module 3 (Panel Management) systematizes the process of managing, assigning and delegating tasks to professional standards' administrators and volunteers. Module 4 (Reporting) processes all findings to generate summary reports as well as highly detailed reports based on the Case Administration system and its results.

### CROSS REFERENCE TO RELATED APPLICATIONS

This application claims priority of provisional application 62/034,255, filed Aug. 7, 2014.

### FIELD OF THE INVENTION

This invention relates to the management and self-policing of the code of ethics by an industry or company for the industry or company's workforce.

### BACKGROUND OF THE INVENTION

In 1908, the National Association Real Estate Exchanges was created with a goal of standardizing how real estate transactions were managed. As part of the original charter of the organization, standards of practices based on ethics were one of the founding principles of the organization. In 1913 the Realtor® code of ethics was adopted. The code of ethics and membership to the National Association of Realtors® is what differentiates a licensed real estate person from a Realtor®. There are currently nearly 2 million licensed real estate persons in the United States but only the 1 million who belong to the National Association of Realtors® and who abide by the code of ethics may be called Realtors®. The code of ethics is a living document and has been amended 37 times. It protects sellers, buyers, landlords, tenants, and all others including real estate professionals who rely on the ethical practice of real estate by Realtors®.

The National Association of Realtors® (NAR) is a self-policing professional association industry trade group. There are 1400 associations country-wide that include both state associations and local associations. These 1400 associations currently manage the process of Professional Standards and Practices using a series of unconnected applications, filing systems, paper-based processing and workflow and in-person meetings, conferences and discussions to administer and support the process of enforcing the code of ethics. Staff administrators have struggled with a means to effectively manage and administer the cases as well as to provide the level of detail and reporting required to provide visibility into areas and trends of violation. The ability to see trends provides a call to action for administrators and staff members across the country to address issues, provide training and/or weed out individuals who do not follow the standards of practice.

By enforcing the code of ethics and providing transparency and visibility into real estate practitioners who violate the standards, the industry is able to raise the bar and protect consumers and other real estate practitioners against fraud and other damaging behavior and negative consequences.

Their exists a need to manage the code of ethics for the 1400 associations hat service over 1 million Realtors® in the management and practice of the National Association of Realtors® code of ethics issues submittal, grievance submission, case administration, panel management and report. There is a similar need in other industries with both licensed and unlicensed professionals, employees, independent contractors, sub-contractors and workforce where there is a code of ethics, and/or professional standards, and/or standards of practice whereby an association, trade group and/or company has a system to submit a grievance or request for mediation and/or arbitration.

### SUMMARY OF THE INVENTION

In accordance with the invention, a system and method are provided for insuring the accountability and self-policing of a code of ethics, or the like, for various entities, such as for the management and enforcement of the National Association of Realtors® code of ethics. As will be apparent, the invention is not limited to use for this organization. The system may comprise 4 modules.

Module 1 delivers a submission process for consumers (buyers, sellers, landlords, tenants, and any type of Realtor®) to file a Grievance Complaint (referred to as “Complaint” from here) or Request for Arbitration (referred to as “Request” from here) with the local association and/or state association stored at a defined application database and comprises the steps of the process of filing either a Complaint or a Request. The database communicates with the application (Case Administration) once the Complaint or Request has been submitted. Prior to submission of the Claim or Request, the system captures a series of answers to questions, supplying additional questions based on previous results information supplied. The system also captures relevant case documentation and routes accordingly moving documentation through a series of checkpoints within the system.

It is a feature of the system that it can track for a Respondent, the number of alleged violations, the corresponding Article of the code of ethics, the Standards of Practice and the detailed description of alleged violation.

It is a feature of the system that it can track the history of multiple Complainants or Respondents, building in a routing mechanism to Module 2 through the application database.

It is a feature of the system that it can connect with one of many databases to capture association member records, validate membership and process a submission based on that status of membership. The application database will bridge any gap between the invention's data and that of the association. The code server is programmed to compare the result of the Complainant or Claimant's input for a Respondent and that of the association's membership record.

It is a feature of the system that it can remember the step in the process in which the user may depart from the submission form and continue from that point forward.

Module 2 provides a system that incorporates workflow automation, collaboration, document generation and calendaring events that are all governed by the business logic that is tied specifically to the NAR code of ethics documentation and can be modified for other professional and industries. The system comprises of a series of panels that display data-driven information based on logic and rules of the code of ethics. Data is displayed at Summary and Detail levels and is particular to a specific step in the process or a specific case. A set of processes are triggered at the point a case is submitted, reviewed by association staff, responded to by the parties involved, or reviewed by any number of the association volunteers (number is variable depending on size of committee body) assigned to the case. The code server is programmed to route cases through the system correlating with the decisions and status applied throughout the 7 step process. At any given step (of 7) one of 12 different actions can be triggered.

It is a feature of the system that it can generate documents for the purpose of communicating the pending case with the parties of the case.

It is a feature of the system that based on the stated rules inherent in the code of ethics, the system can trace the case decisions and outcomes for each step in the process, tracking the results per Respondent, Per Article. Traceability extends from the initial submission of a Complaint or Request all the way through Sanctions and until the Case is “Closed,” noting complete resolve.

Module 3 provides a system that manages the participation of the association's volunteers who serve on Professional Standards committees or to review and decide Arbitration Requests. The system contains a sub-system that is capable of generating a random set of panels comprised of volunteers, starting with a large population and ending with discrete sets of approximately 5 to 10 individuals as appropriate. The dataset is then further acted upon and another set of calculations are performed to generate a series of hearings and dates.

It is a feature of the system that generates calendar requests, sent in real-time, to all volunteers.

It is a feature of the system that all data associated with a specified panel meeting or hearing date can be further edited, changed or removed by association staff.

It is a feature of the system that the module communicates with the application database and is able to store information in real time.

It is a feature of the system that at any time a case may be moved out of the current workflow process and into Abeyance which is required if the case is pending civil or criminal litigation in another court or licensing entity.

Module 4 provides a system that communicates with the application database and can generate reporting that is aggregated across the entirety of a local and/or state association. Aggregated data is consolidated through a series of processing rules within the application database. The system also performs a number of requests that comprise the logic required to generate reports based on the case detail including but not limited to the Respondent, the Articles Violated, and the Case Decisions as each step of the ethics or Arbitration process.

It is a feature of the system that all application reporting data may be accessed and readily made available with state and national organizations, as appropriate. This is important as it demonstrates the industry's ability to safeguard real estate transactions and professional practices across the nation.

### BRIEF DESCRIPTION OF THE DRAWINGS

FIG. 1 is a block diagram showing a system in accordance with the invention;

FIG. 2 is a flow diagram illustrating a process of submitting an ethics or grievance complaint;

FIG. 3 is a flow diagram illustrating a process of submitting a request for arbitration or mediation;

FIG. 4 is a flow diagram illustrating a process of reviewing a case and setting up a response to the allegation and assigning a panel as shown in FIG. 12;

FIG. 5 is a flow diagram of a grievance process and the steps involved in hearing a case, allowing for a series of appeal hearings and illustrates how external communication is handled via email;

FIG. 6 is a flow diagram of the case hearing process and the steps involved in setting a hearing date, communicating with panel and case parties and steps leading to an Appeal Hearing;

FIG. 7 is a flow diagram of the hearing appeal process and the steps required to administer a case through ratification by a board of directors, applying sanctions and closing the case;

FIG. 8 is a flow diagram of the process to administer a request for mediation or arbitration;

FIG. 9 is a flow diagram of the hearing appeal process to administer a request for mediation or arbitration;

FIG. 10 is a flow diagram depicting the process to manage member volunteers;

FIG. 11 is a flow diagram depicting the process to generate panels of member volunteers for any of the three types of committees; and

FIG. 12 is a flow diagram depicting the process to generate reports based case status and history.

### DETAILED DESCRIPTION OF THE INVENTION

The invention described herein relates to the way the code of ethics is managed and self-policed by the industry or company for the industry or company's workforce and includes the mechanism to intelligently administer cases for either professional standards ethics violations or arbitration requests. The system can provide accountability at the local, state and national levels of an industry and/or state societies, chapters or other governing bodies and/or within a company in respect to its employees, independent contractors, sub-contractors and other workforce individuals.

In accordance with the invention, a case administration and management system has been designed to support any industry or company that is self-policing and relies upon its' member constituents, members of the general public (consumers) or staff to submit a complaint and for a governing body to administer and enforce a code of ethics and or standards of practice for the betterment of its industry or company.

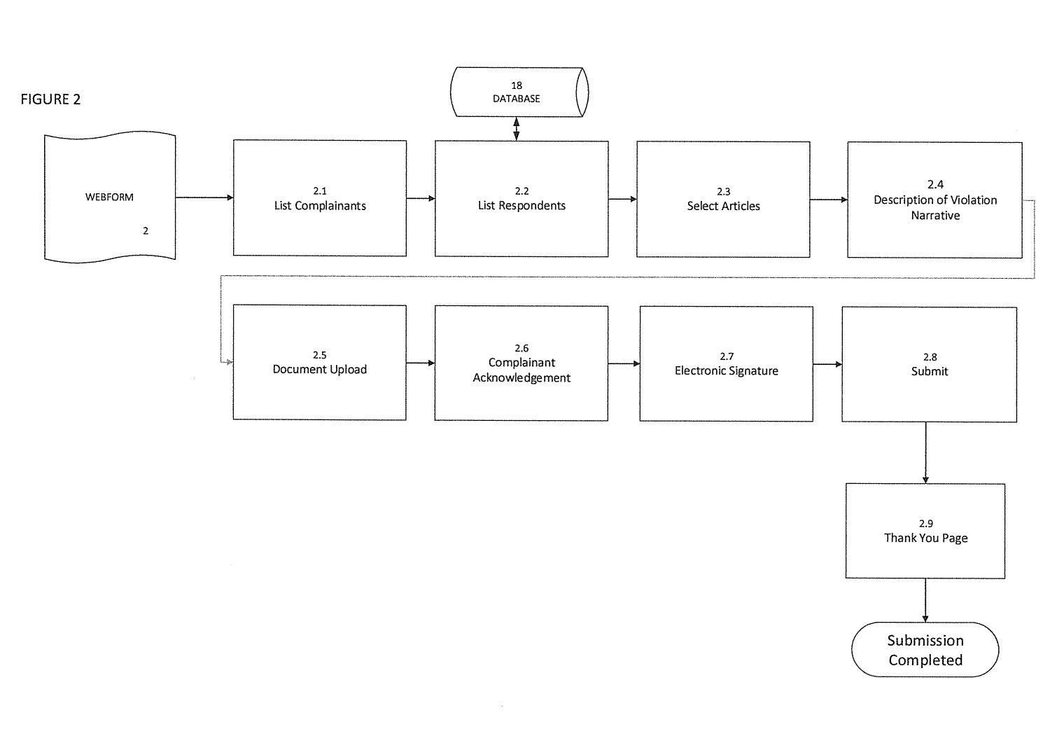

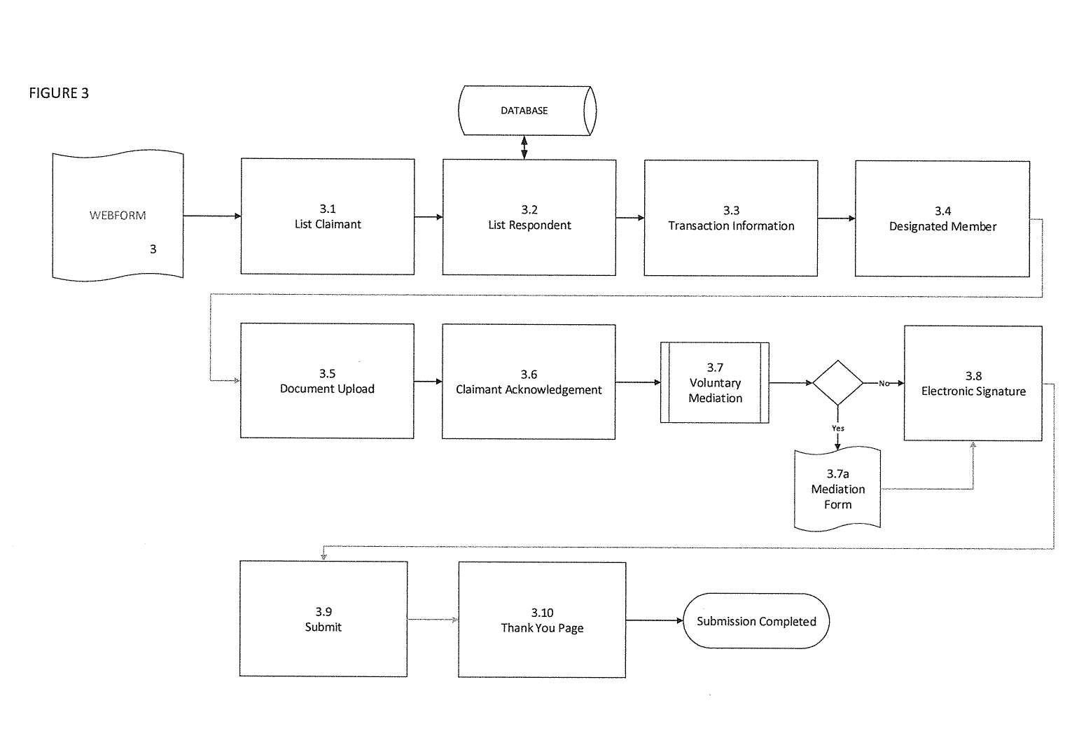

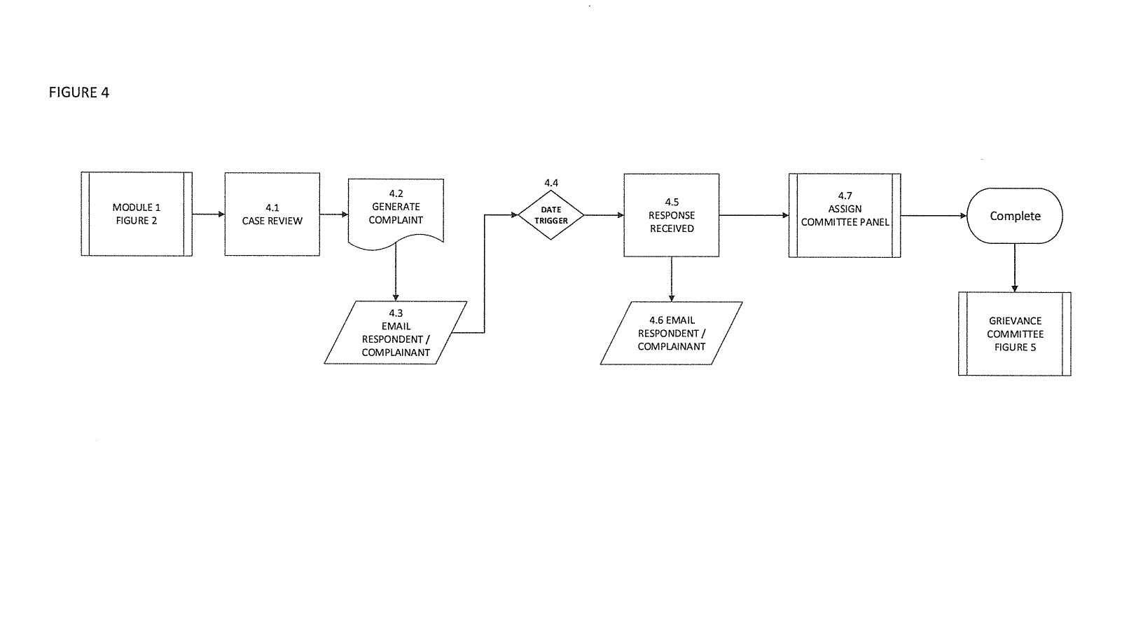

The system is comprised of four modules. MODULE 1 of the system provides data submission functionality as illustrated by FIG. 2 and FIG. 3. MODULE 2 provides a system that incorporates workflow automation, collaboration, document generation, automatically generated email communications and calendaring events that are all governed by the business logic as dictated by the code of ethics or other standards of practice documentation. This is generally illustrated in FIGS. 4, 5, 6, 7, 8, and 9.

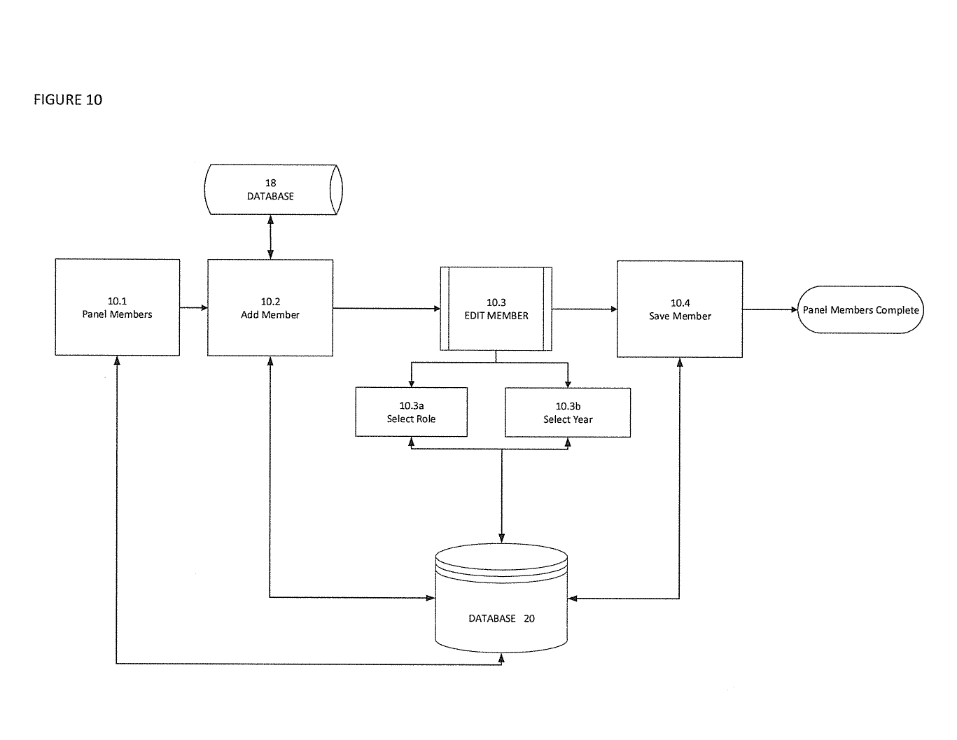

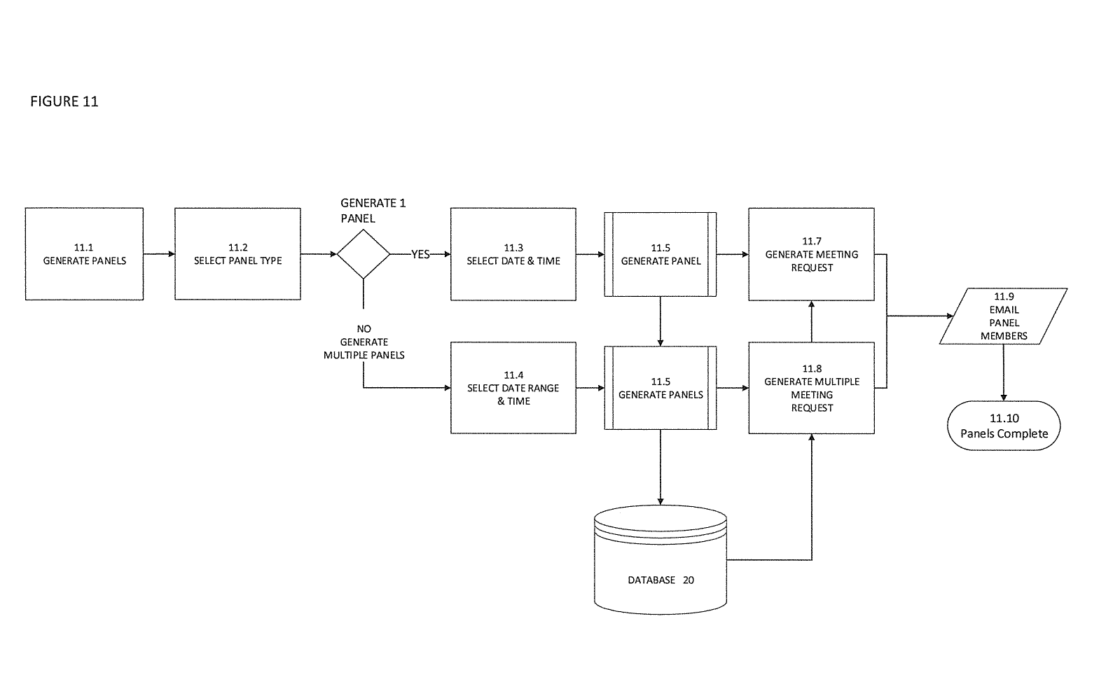

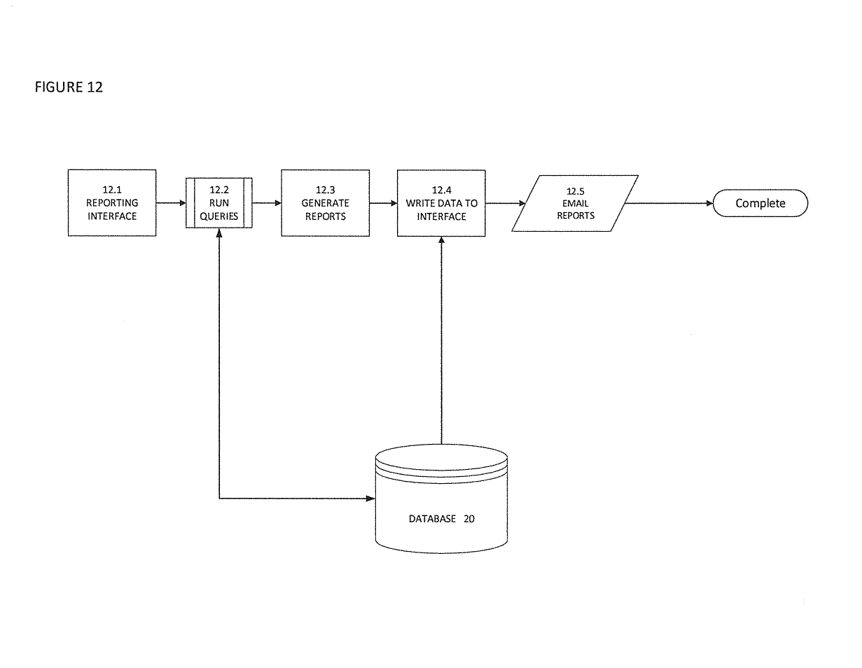

MODULE 3 provides a system that manages the participation of the association's volunteers who serve on Professional Standards committees or to review and decide Arbitration Requests. The system contains a sub-system that is capable of generating a random set of panels comprised of volunteers, starting with a large population and ending with discrete sets of seven to ten individuals. The dataset is then further acted upon and another set of calculations are performed to generate a series of hearings and dates. FIG. 10 and FIG. 11 illustrate the workflow that dictates the actions of the system. MODULE 4 provides a system that communicates with the application database and can generate reporting that is aggregated across the entirety of a professional or industry organization. Aggregated data is consolidated through a series of processing rules within the application database. The system also performs a number of requests that comprise the logic required to generate reports based on the case detail including but not limited to the Respondent, the Articles Violated, and the Case Decisions as each step of the Ethics or Arbitration process. FIG. 12 illustrates the workflow that supports the functionality of the system.

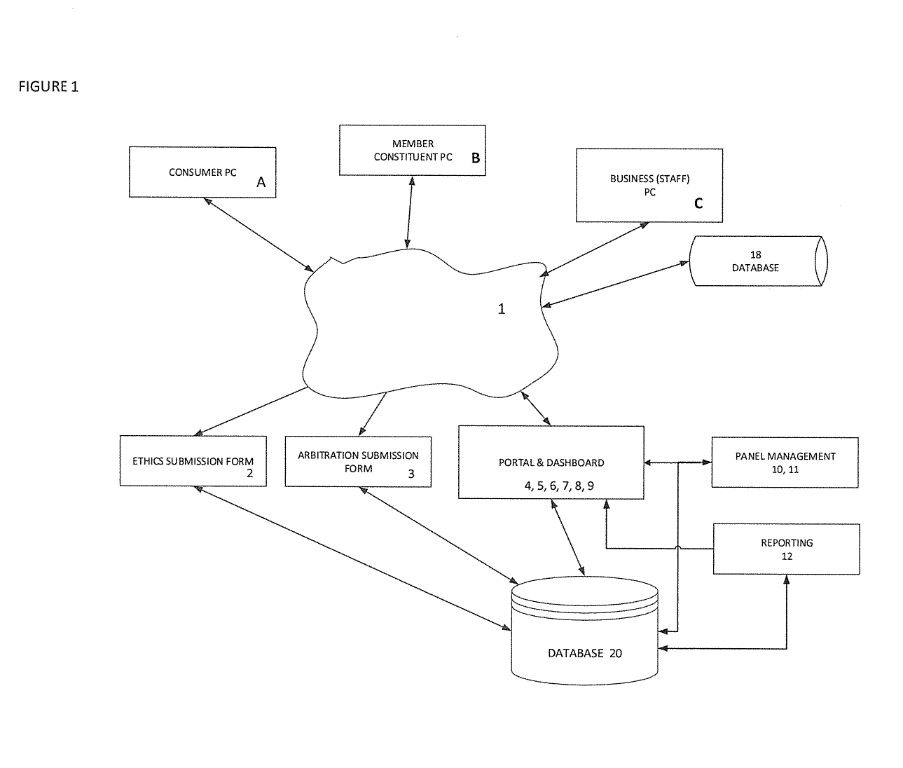

Referring to FIG. 1 a block diagram that shows three user types, namely a consumer A, a member constituent B, and a professional/industry staff member C, and how they access and interact with the invention. A cloud 1 represents a communication network for providing electronic communications. The network 1 may comprise any available network such as a telephone network the internet, cellular, or any other means by which any of the user types can access the invention. Connected to the network 1 are consumer PC A or any device capable of using a web browser, a member constituent PC B or any device capable of using a web browser, or a professional or industry staff administrator's PC C or any device capable of using a web browser. Also connected are items such as an ethics submission form 2, a request for mediation or arbitration 3, and a portal & dashboard 4, collectively the invention, which are used to submit ethics complaints and requests for mediation or arbitration and the system by which the process is governed.

FIG. 2 illustrates the detailed workflow of the ethics complaint submission process using the system of FIG. 1. The submission process for an ethics complaint begins when consumer A or member constituent B files a complaint through ethics submission form 2. Complainants (consumer A or member constituent B) are entered into the system at a block 2.1. The respondents are identified through a connection with the professional or industry database 18 of member constituents at a block 2.2. A data query returns the possible set of members from which Consumer A or member constituent B selects the respondent. Select articles is a generated set of code of ethics articles and the invention requires the selection of at least one at a block 2.3 and a narrative description is entered at a block 2.4. Supporting documentation is incorporated and uploaded into the cloud network 1 at a block 2.5. The Complainant from the block 2.1 completes the set of acknowledgements at a block 2.6 and depending upon the result of those acknowledgments the case may take a separate path. An electronic signature and certification is completed at a block 2.7 and the complaint is submitted at a block 2.8. A thank you page is served via the web to the Complainant at a block 2.9 and the submission process is completed. When the process is completed a GUID is generated in the database and the case number is generated along with the case history as supplied by the complainant at the block 2.1.

FIG. 3 illustrates the workflow when a request for mediation or arbitration is submitted. The process begins when member constituent B files a request for mediation or arbitration through a web form 3. Claimants (member constituent B) are entered into the system at a block 3.1. The respondents are identified through a connection with the professional or industry database of member constituents at a block 3.2. A data query returns the possible set of members from which member constituent B selects the respondent. Transaction information is updated into the web form 3 at a block 3.3. A designated member who can serve as proxy for the respondent 3.2 is entered at a block 3.4. Supporting documentation is incorporated and uploaded into the cloud network 1 at a block 3.5. The claimant completes the set of acknowledgements and depending upon the result of those acknowledgments the case may take a separate path at a block 3.6. Voluntary mediation is offered at this step of the invention at a block 3.7. The claimant can choose to seek voluntary mediation or request arbitration. If voluntary mediation is requested, then a mediation form will be displayed and the claimant will complete the form at a block 3.7a prior to providing an electronic signature at a block 3.8 and final submission of the request for mediation or arbitration at a block 3.9. A thank you page is served via the web to the claimant at a block 3.10 and the submission process is completed. When the submission is completed a GUID is generated in the database and the case number is generated along with the case history as supplied by the claimant.

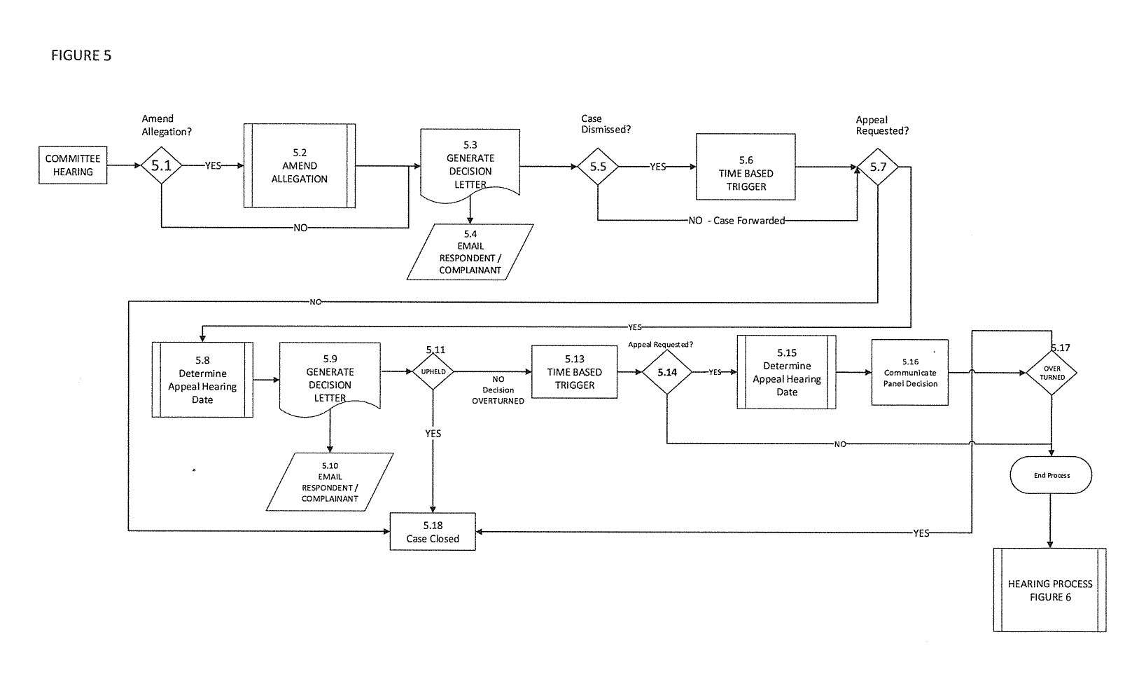

FIG. 4 illustrates the workflow for data flowing in from FIG. 2. Professional or industry business staff C interact with the portal and dashboard that is hosted in the cloud network 1. A block 4.1 illustrates the process by which professional staff C review case history of all supplied and submitted information from the complainant for the ethics complaint. Upon review and consideration of the information a complaint is generated by the system at a block 4.2 where an algorithm will generate the complaint using supplied information as shown in FIG. 2. An email is automatically generated to the complainant (2.1) and to the respondent (2.2) with the complaint included at a block 4.3. A data trigger has been incorporated into the logic of the system at a block 4.4 to track a response deadline given previously entered details. Once the respondent supplies the response to the allegation at a block 4.5 it is entered into the system. An email communication is generated by the system at a block 4.6 and the portal and dashboard tracks additional data for the case as identified through a unique case ID and algorithm as established in the submission at the block 2.8. At a block 4.7 a committee panel is assigned to hear the case based on an algorithm that examines data from the complainant, the respondent and the case review and that meets the criteria established in the business rules governing minimum number of days prior to hearing date. With a panel assigned the case moves to the grievance committee hearing process shown in FIG. 5.

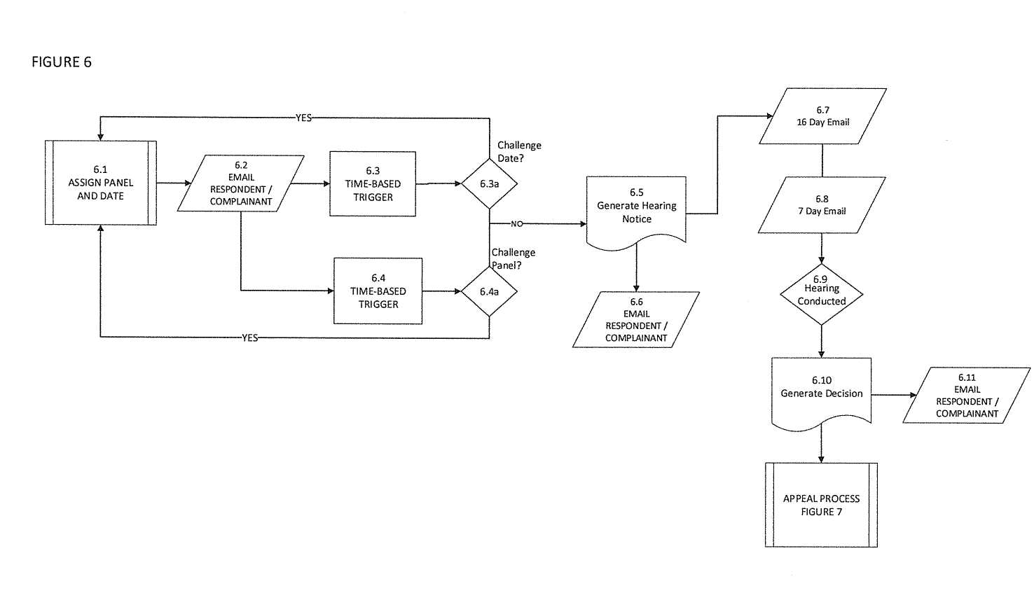

FIG. 5 describes the process and logic that governs the following steps as a case moves through the system of FIG. 4. If case allegations need to be amended at a block 5.1, then at a block 5.2 a sub-process will be invoked to permit data updated using components of complainant (2.1), select articles (2.3), description of violation narrative (2.4) and document upload (2.5). If the case is not amended, then it proceeds to at a block 5.3 to generate a decision letter which describes the findings of the committee panel at the block 4.7. At a block 5.4 an email is generated and delivered to the complainant and the respondent. If the case is dismissed at a block 5.5 it will move into a time-based trigger at a block 5.6. The logic for the time-based trigger dictates the number of days allowed to appeal a decision. If the Case is not dismissed but is forwarded then the same time-based trigger is allotted to the complainant and the respondent. If the appeal is not requested at a block 5.7 the system automatically routes the case to case closed at a block 5.18. If an appeal is requested then an appeal hearing date is identified at a block 5.8 and conducted. At a block 5.9 a decision letter is generated by the system and email generated at a block 5.10 to notify the complainant and the respondent. If the case decision is upheld at a block 5.11 the case moves to the block 5.18 case closed status. If the finding is overturned a subsequent time-based trigger is engaged at a block 5.13 to govern the number of days until the option to appeal period is expired. At a block 5.14 if no appeal requested then the process ends. If an appeal is requested then at a block 5.15 an appeal hearing panel will be identified and the case will be heard. At a block 5.16 the decision of the appeal hearing panel will be communicated and if is overturned at a block 5.17 it will be closed at the block 5.18. If not overturned the case will proceed to FIG. 6 the Hearing process.

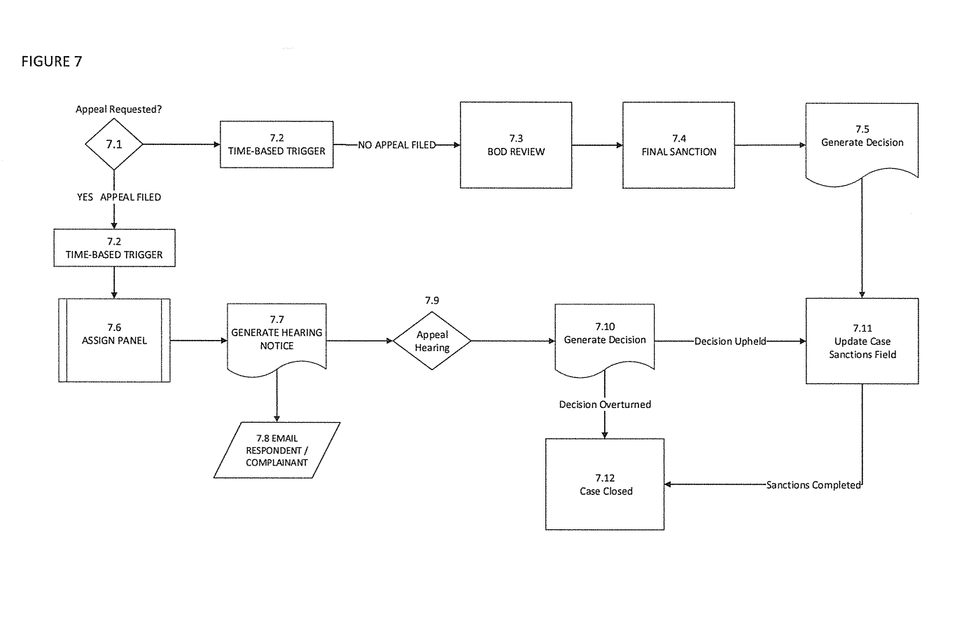

FIG. 6 illustrates the steps a case will go through for a Hearing process. At a block 6.1 a hearing panel will be identified and prior to hearing the case an email will be communicated to the complainant and the respondent at a block 6.2 with the date and panel assigned to hear the case. At a block 6.3 a time-based trigger is designed into the logic so that both the complainant and the respondent have the ability to challenge the date at a block 6.3a. If the date is challenged, the system will reroute the case through the block 6.1 to assign the next available panel and date. If the date is not challenged then the system will wait at a block 6.4a for the time-based trigger of the block 6.4 for whether the complainant or the respondent challenges the panel. If the challenged, the case will be routed back to the block 6.1 to find the next panel and hearing date. If neither are challenged at the blocks 6.3a nor 6.4a then the system will generate hearing notice at a block 6.5 and email the complainant and the respondent at a block 6.6. A series of time-based emails are generated including at a block 6.7 a sixteen day email to all parties regarding the upcoming date. The system alerts the professional/industry staff C of upcoming hearing dates. At a block 6.8 a seven day email is generated and is delivered only to the chairperson of the committee panel who will hear the case. At a block 6.8 a hearing is conducted the result of which is entered and generated at a block 6.10 generate decision and an email is sent to the complainant and the respondent at a block 6.11. The appeal process for a hearing is depicted in FIG. 7.

FIG. 7 describes the process of routing a case through a hearing appeal process through to when all complainants are complete and the case is closed. At a block 7.1 if the respondent files an appeal then a time-based trigger begins at a block 7.2 and the system will determine the number of days available to file an appeal. If no appeal is requested then the case moves to a block 7.3 board review where the final sanctions are heard at a block 7.4 and the board ratifies them. At a block 7.5 a decision is generated and at a block 7.11 the sanctions are entered into the system and tracked against time-based triggers so professional/industry staff C can monitor corrective activity completion and payment of any monetary fines. If an appeal is requested at the block 7.1 the case moves to a block 7.6 and a panel is assigned to hear the case. At a block 7.7 the hearing notice is generated and at a block 7.8 an email is sent to the complainant and the respondent. At a block 7.9 an appeal hearing is conducted and the system generates the decision of the hearing panel at a block 7.10. If the decision is upheld, the final sanctions from the block 7.4 will be updated at the block 7.11 case sanctions field. If the decision is overturned then the case proceeds to a block 7.12 and the case is closed. Once all sanctions have been completed and fulfilled the case moves to case closed at the block 7.12.

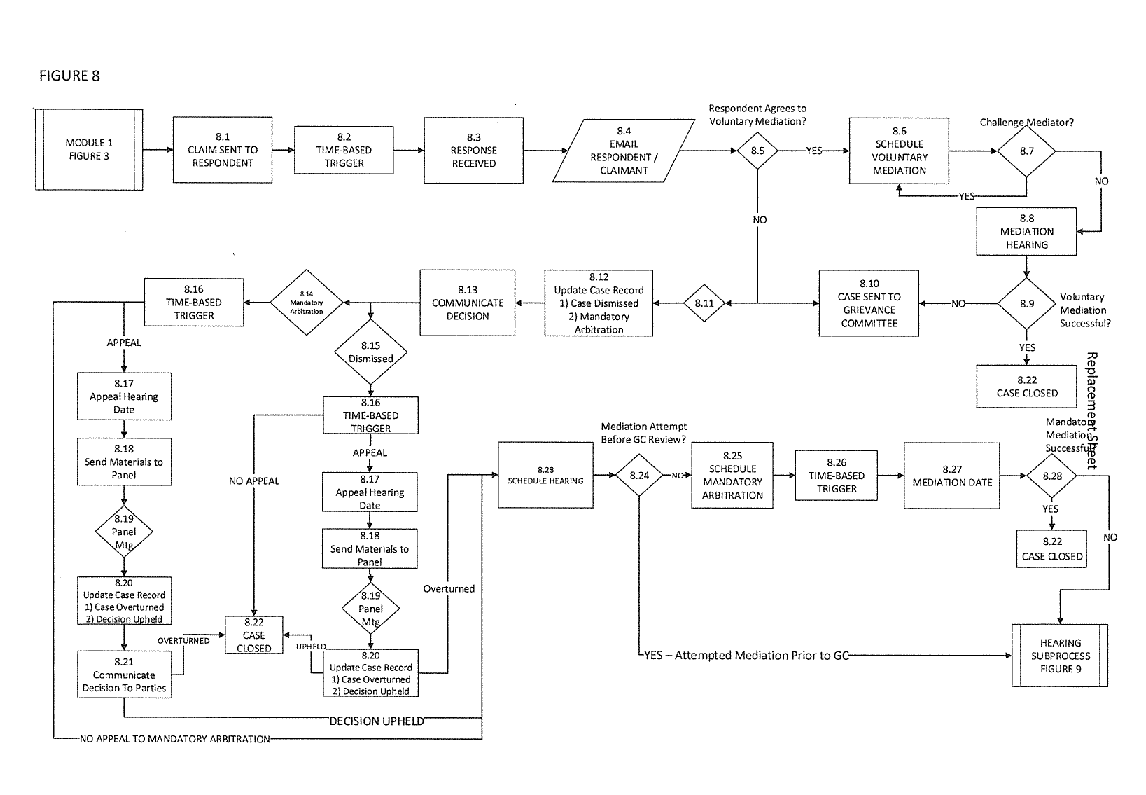

FIG. 8 describes the process of routing a request for mediation or arbitration 3 through the portal and dashboard 4. At a block 8.1 a claim is sent to the respondent, see the block 3.2, and a time based trigger is invoked at a block 8.2. Once the respondent submits a response at a block 8.3 to the allegation the system emails a copy of response at a block 8.4 to both the claimant and the respondent. If both parties agree to voluntary mediation at a block 8.5, then the at a block 8.6 schedule voluntary mediation occurs. Parties have the right to challenge the mediator at a block 8.7. If yes, then the block 8.6 runs again and a new mediator is identified. If not challenged then a mediation hearing is conducted at a block 8.8. At a block 8.9 if mediation is successful then case is closed at a block 8.22. If mediation is not successful then at a block 8.10 the case is forward to grievance committee. At a block 8.11 a committee hears case and the case record is updated. At a block 8.13 the case decision is communicated to the claimant and the respondent.

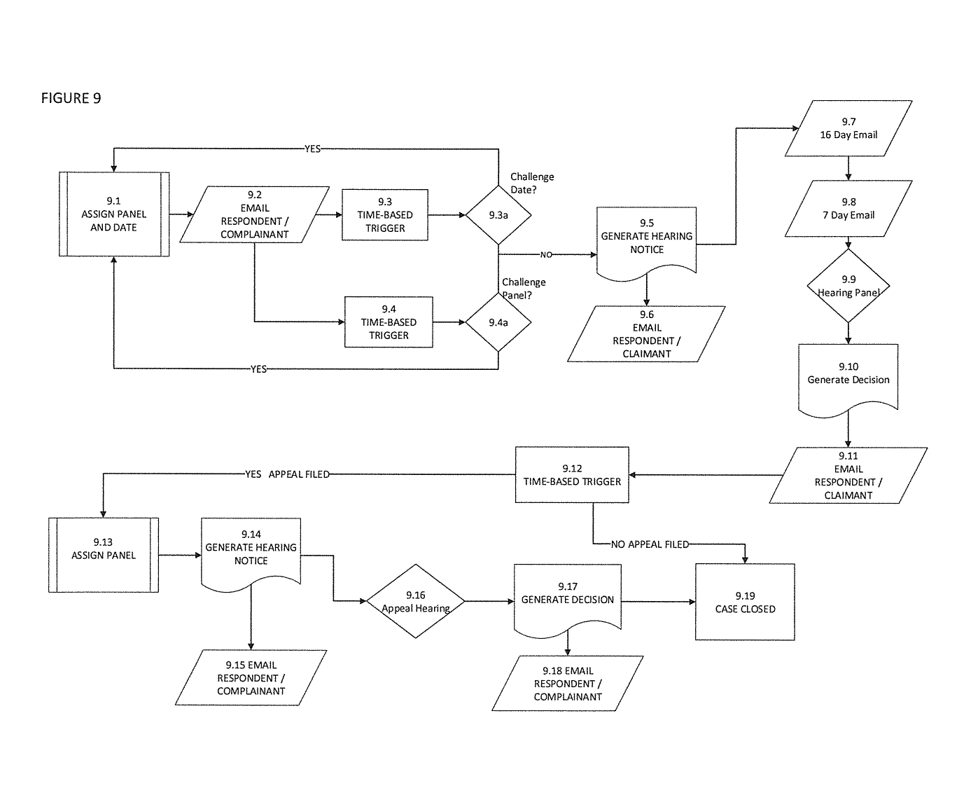

The case can be assigned to mandatory arbitration at a block 8.14 or dismissed at a block 8.15 dismissed. Whether mandatory arbitration or dismissed the process follows same steps. A time-based trigger is initiated at a block 8.16. The time-based trigger dictates the amount of days before the appeal period expires. If no appeal is requested for a dismissed case then the case moves to case closed at a block 8.22. If no appeal is requested for an arbitration the process moves case to a schedule hearing block 8.23. Otherwise, with an appeal, an appeal hearing date is set at a block 8.17 and the system send materials at a block 8.18 to panel for appeal hearing at a block 8.19. At a block 8.20 the case record is updated with case decision. At a block 8.21 the decision is communicated to the claimant and the respondent. For mandatory arbitration appealed and overturned case is closed at the block 8.22. If decision is upheld case moves to schedule hearing at a block 8.23. For case dismissed when appealed and upheld case moves to case closed at the block 8.22. If the case dismissed is appealed and overturned then case moves to schedule hearing at the block 8.23. The schedule hearing views at a block 8.24 whether voluntary mediation was attempted. If not then at a block 8.25 mandatory arbitration is scheduled. At a block 8.26 a time-based triggers sets number of days prior to mediation date at a block 8.27. If mediation is successful at a block 8.28 then case closed at the block 8.22. If mediation is unsuccessful at the block 8.28 then case proceeds to the FIG. 9 hearing process.

FIG. 9 illustrates the steps a case will go through for a hearing process. A hearing panel will be identified at a block 9.1 and prior to hearing the case at a block 9.2 an email will communicate to the claimant the respondent the date and panel assigned to hear the case. At a block 9.3 a time-based trigger is designed into the logic so that both the claimant and the respondent have the ability to challenge the date at a block 9.3a. If the date is challenged, the system will reroute the case through the block 9.1 to assign the next available panel and date. If the date is not challenged then the system will wait for the time-based trigger at a block 9.4 for whether the claimant or the respondent will challenge the panel at a block 9.4a. If the panel is challenged, the case will be routed back to the block 9.1 to find the next panel and hearing date. If neither are challenged then the system will generate a hearing notice at a block 9.5 and at a block 9.6 email the claimant and the respondent. A series of time-based emails are generated including at a block 9.7 a sixteen day email to all parties regarding the upcoming date. The system alerts the professional/industry staff C of upcoming hearing dates. At a block 9.8 a seven day email is generated and is delivered only to the chairperson of the committee panel who will hear the case. At a block 9.9 a hearing is conducted the result of which is entered and generated at a generate decision block 9.10 and at a block 9.11 an email is sent to the claimant and the respondent. At a block 9.12 a time-based trigger specifies the number of days for the appeal period. If no appeal is requested then the case is closed at a block 9.19. If an appeal is requested then a hearing panel is assigned at a block 9.13. At a block 9.14 the system generates the notice of hearing and at a block 9.15 an email is sent to the claimant and the respondent. At a block 9.16 a hearing is conducted and at a block 9.17 a decision is generated and at a block 9.18 an email is sent to the claimant and the respondent. The case is closed at the block 9.19.

FIG. 10 illustrates the process flow for administering (add, edit, delete) member volunteers who participate as panel members to hear ethics complaints and mediation or arbitration requests as stored in the database 20. Block 10.1 is the complete listing of all members who participate in the professional standards process. At a block 10.2 members are added to the complete panel member listing by making a call to the member database 18 to access current active members using SOAP protocol to dynamically connect in real-time to the member database 18 and return results based on user inquiry. An edit member block 10.3 involves a select role sub-process 10.3a to select member roles comprised of grievance committee, professional standards or arbitration and the role served (chair or member), and a select year sub-process 10.3b provides flexibility for member volunteers to serve on multiple committees throughout multiple years without impacting data relationships at the process level (seethe blocks 4.7, 5.8, 5.15, 6.1, 7.6). An add member function at a block 10.2 is complete when professional/industry staff C select the member, edit role and year, and save updates at a block 10.4 to the 20 database.

FIG. 11 describes the process by which committee panels are generated for each of the three types of committees: grievance committee, professional standards and arbitration. A block 11.1 provides the controls to generate panels and invite members. A block 11.2 select panel type from one of the aforementioned committee types. If a single panel is generated then the system selects the date and time at a block 11.3. If multiple panels are generated professional/industry staff C selects a date range beginning from date to ending date. Panel(s) is/are generated at a block 11.5. An algorithm has been designed to take into multiple factors including corporate/company affiliation, numbers of times served, role served on a prior panel and will identify a panel of seven members for each date and time. The invention will flag the respondent (2.2) or respondent (3.2) or designated member (3.4) to track and ensure there is no overlap or duplication in corporate/company affiliation. A generate meeting request block 11.7 will create a single .ics file that will be emailed to panel members at a block 11.9. A block 11.8 generates an .ics file for each of the multiple panels generated to email panel members at the block 11.9.

Referring to FIG. 12 a reporting interface block 12.1 provides an entry point to request and generate queries at a block 12.2 against the database 20 to generate reports at a block 12.3 based on query details. One generated report is written at a block 12.4 to the interface to deliver to user via a web call or emailed to user at a block 12.5.

1. An ethics complaint or request for mediation and/or arbitration method implemented in a computer processing system comprising:
complaint submission and/or request for mediation or arbitration;
real-time look up to validate member record;
captures relevant information including upload of supporting documents;
process submission and/or requests based upon status of membership;
computer system can remember the step in process and continue from that point forward to complete the submission of complaint or request for mediation/arbitration.

2. Case processing method implemented in a computer processing system wherein workflow automation, document generation and event calendar triggers are governed by business logic determined by:
an association, trade group and/or company input and/or guideline;
follows a process of case submission, staff review, responses by parties involved, reviewed by volunteers;
case is routed through system correlating to decisions through a defined step process which triggers subsequent defined actions;
system can generate documentation on case to parties involved;
system can trace each step in process including decisions and subsequent outcomes from complaint submission or request for mediation or arbitration through sanction and case closed noting complete resolve.

3. The volunteer panel management method in a computer processing system that identifies, manages, assigns and delegates tasks to both staff and association, trade group and/or company volunteers implemented within a computer processing system comprising:
a panel committee to review 3 different types of panels: 1) grievance panel, 2) professional standards, 3) arbitration for mediation or arbitrations;
sub-system capable of generating a random set of panel volunteers;
business logic with ability to recuse panel members automatically;
ability to manually recuse panel member by staff override into system;
system ability to generate a series of hearings and date sensitive actions;
system ability to send calendar requests to all volunteers;
system ability to communicate with application database and store information in real time;
case can be manually removed from current workflow process and put into Abeyance if case is pending civil or criminal litigation in another court or licensing agency.
